(19) United States
(12) Patent Application Publication
(10) Pub. No.: US 2013/0145374 A1
(43) Pub. Date: Jun. 6, 2013

(54) SYNCHRONIZING JAVA RESOURCE ACCESS

(71) Applicant: International Business Machines Corporation, Armonk, NY (US)

(72) Inventors: Peter F. Sweeney, Yorktown Heights, NY (US); Qiming Teng, Beijing (CN); Haichuan Wang, Beijing (CN); Xiao Zhong, Beijing (CN)

(73) Assignee: International Business Machines Corporation, Armonk, NY (US)

(21) Appl. No.: 13/661,842

(22) Filed: Oct. 26, 2012

(30) Foreign Application Priority Data
Oct. 31, 2011 (CN) 201110347003.9

(51) Int. Cl. G06F 9/52

(52) U.S. Cl. CPC G06F 9/52
USPC 718/104

(57) ABSTRACT

A method and an apparatus for synchronizing Java resource access. The method includes configuring for a first access interface of a resource set, a first monitor, and configuring, for a second access interface of the resource set, a second monitor, configuring, for the first monitor, a first waiting queue, and the second monitor, a second waiting queue, in response to the first access interface receiving an access request for a resource from a thread, the first monitor querying whether the resource set has a resource satisfying the access request, in response to a positive querying result, the thread obtains the resource and notifies the second monitor to awake a thread in the second waiting queue, in response to a negative querying result, the first monitor puts the thread in the first waiting queue to queue up.

### CROSS-REFERENCE TO RELATED APPLICATION

This application claims priority under 35 U.S.C. §119 from Chinese Patent Application No. 201110347003.9 filed Oct. 31, 2011, the entire contents of which are incorporated herein by reference.

### BACKGROUND OF THE INVENTION

1. Field of the Invention

The present invention relates to Java resource access, and in particular, relates to a method and an apparatus for synchronizing Java resource access.

2. Description of Related Art

Currently, multi-core and multi-threaded servers have become widely used. As one of the major development languages for server applications, Java is capable of implementing and managing multi-threaded application. Java also realizes thread synchronization utilizing a monitor mechanism. FIG. 1 illustrates the existing synchronization model of Java resource access, where a monitor for data protection includes three portions: an entry region, a possession region, and a waiting region, where the entry region and waiting region may have a plurality of threads, but at any time, there is only one thread to the utmost to possess the monitor. The operation primitives for the thread to the monitor are specified below:
“entering” the monitor denotes that a thread entering into the entry region to prepare for obtaining the monitor; at this point, if no other thread possesses the monitor, then the thread proceeds to obtain the monitor; otherwise, it has to wait in the entry region;
“obtaining” the monitor denotes the operation that selects a thread in the entry region and waiting region to be eligible for possessing the monitor according to a certain strategy;
the thread “possessing” the monitor exclusively holds the monitor when it possesses the monitor, thus preventing the entry of any other threads;
“releasing” the monitor: the thread possessing a monitor, after executing the codes within the monitor scope or exiting abnormally, should release the monitor it possesses.

The monitor's scheduling principle with respect to the waiting threads is specified below: at most one thread may reside within a critical region at any time; a thread is not allowed to reside unlimitedly within the critical region; it is not allowed to force one thread to wait unlimitedly for entering into the critical region; it is not allowed to cause thread starving, even dead lock, according to the selected scheduling policy. for a model of producer thread or consumer thread, only one producer thread is allowed to produce at a time, and only one consumer thread is allowed to consume at a time. While a producer thread is producing some resource, a consumer thread cannot consume. When a resource set is full, the producer thread cannot continue to produce, and when the resource set is empty, the consumer thread cannot continue to consume.

However, the thread synchronization implemented by the prior art monitor mechanism cannot distinguish the types of waiting threads. Instead, it selects one thread randomly from the waiting threads to obtain the monitor. For the producer and consumer model, the resource set has available resources but without available space. If what is randomly selected is a producer thread, then the producer thread that needs to add resources to the resource set can not make any progress even it can obtain a monitor. Further, when the resource set has available space but no available resource, if what is randomly selected is a consumer thread, then the consumer thread that needs to obtain resource from the resource set should not obtain a monitor, such that the access performance of the resource set is deteriorated and cannot be expanded to a large-scaled system.

Many queues or queue alike resource sets exist in a multi-staged Java enterprise application, therefore, the efficiency of a resource set is extremely important to the performance and scalability of the overall application. Therefore, it is desirable for an efficient mechanism for synchronizing Java resource access.

### SUMMARY OF THE INVENTION

In view of the above problems, the present invention provides a method and an apparatus for synchronizing resource access under a multi-threaded Java environment.

According to the first aspect of the present invention, a method for synchronizing Java resource access is provided. The method includes configuring a first monitor, for a first access interface of a resource set, and a second monitor, for a second access interface of the resource set, configuring a first waiting queue, for the first monitor, and a second waiting queue, for the second monitor, in response to the first access interface receiving an access request for a resource from a thread, the first monitor querying whether the resource set has a resource that satisfies the access request, in response to a positive query result, the thread obtaining the resource and notifying the second monitor to awake a thread in the second waiting queue, and in response to a negative query result, the first monitor putting the thread into the first waiting queue to queue up.

According to the second aspect of the present invention, an apparatus for synchronizing Java resource access is provided. The apparatus includes a monitor configuration module to configure a first monitor, for a first access interface of a resource set, and a second monitor for a second access interface of the resource set, a waiting queue configuration module to configure a first waiting queue, for the first monitor, and a second waiting queue for the second monitor, a querying module configured in a way that in response to the first access interface receiving an access request for a resource from a thread, the first monitor queries whether the resource set has a resource that satisfies the access request, a synchronization module configured in a way that in response to a positive query result, the thread obtains the resource and notifies the second monitor to awake a thread in the second waiting queue, and a queuing module configured in a way that in response to a negative query result, the first monitor puts the thread into the first queue to queue up.

According to a third aspect of the invention, a computer readable storage medium tangibly embodying a computer readable program code having computer readable instructions which, when implemented, cause a computer to carry out the steps of a method for synchronizing Java resource access is provided. The method includes configuring a first monitor, for a first access interface of a resource set, and a second monitor, for a second access interface of the resource set, configuring a first waiting queue, for the first monitor, and a second waiting queue, for the second monitor, in response to the first access interface receiving an access request for a resource from a thread, the first monitor querying whether the resource set has a resource that satisfies the access request, in response to a positive query result, the thread obtaining the resource and notifying the second monitor to awake a thread in the second waiting queue, and in response to a negative query result, the first monitor putting the thread into the first waiting queue to queue up.

By using the method and apparatus for synchronizing Java resource access according to the embodiments of the present invention, a synchronization mechanism of Java resources that may efficiently and accurately block and awake a contending thread is essential for enhancing the performance and scalability of the overall application.

### BRIEF DESCRIPTION OF THE DRAWINGS

In conjunction with the accompanying drawings, the invention itself, the preferred embodiments, and the objectives and advantages of the present invention may be better understood through describing in detail the method and apparatus for synchronizing resource access in a Java multi-threaded environment with reference to the following embodiments wherein:

FIG. 1 illustrates an existing monitor model for Java resource access;

FIG. 2 illustrates a method of synchronizing Java resource access according to embodiments of the present invention;

FIG. 3 illustrates a method of synchronizing Java resource access according to one embodiment of the present invention;

FIG. 4 illustrates a method of synchronizing Java resource access according to another embodiment of the present invention;

FIG. 5 illustrates a schematic diagram of a mechanism of synchronizing Java resource access according to embodiments of the present invention;

FIG. 6 illustrates a flow chart of a mechanism of synchronizing Java resource access according to embodiments of the present invention;

FIG. 7 illustrates a block diagram of an apparatus for synchronizing Java resource access according to embodiments of the present invention; and

FIG. 8 illustrates a structural block diagram of a computing device capable of implementing the embodiments according to the present invention.

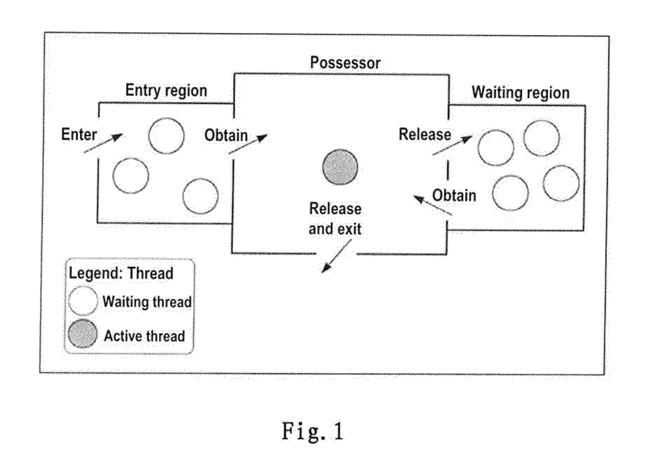

### DETAILED DESCRIPTION OF THE PREFERRED EMBODIMENTS

Hereinafter, the objectives and advantages of the present invention will be better understood through describing the method and apparatus for synchronizing Java resource access according to the embodiments of the present invention in conjunction with the accompanying drawings.

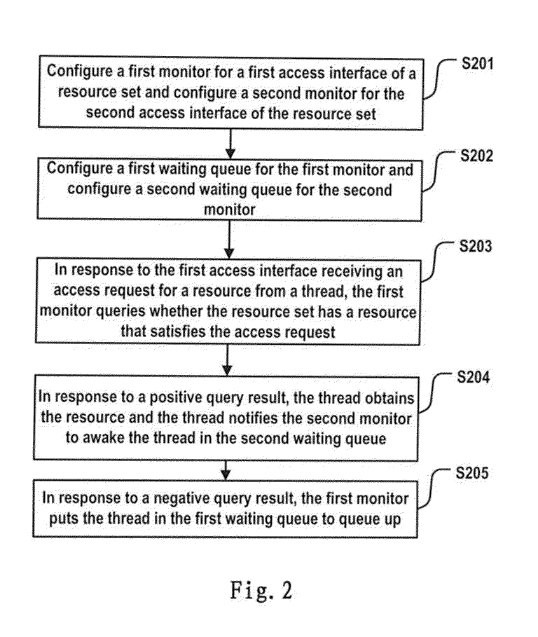

FIG. 2 illustrates a method of synchronizing Java resource access according to an embodiment of the present invention. At step S201, a first monitor is configured for a first access interface of a resource set and a second monitor is configured for a second access interface of the resource set; at step S202, a first waiting queue is configured for the first monitor and a second monitor is configured for the second monitor; at step S203, in response to the first access interface receiving an access request for a resource from a thread, the first monitor checks whether the resource set has a resource satisfying the access request; at step S204, in response to a positive querying result, the thread obtains the resource and notifies the second monitor to awake a thread in the second waiting queue; at step S205, in response to a negative querying result, the first monitor puts the thread in the first waiting queue to queue up.

At step S201, a first monitor is configured for a first access interface of a resource set, and a second monitor is configured for a second access interface of the resource set. Thus, there is a plurality of access interfaces accessing the Java resource set. According to the embodiments of the present invention, the plurality of access interfaces for the Java resource set are categorized, for example, into a producer-type access interface and a consumer-type access interface; the threads are categorized into producer threads and consumer threads based on method call of the threads, where the producer thread adds resources to the resource set through a producer-type access interface, and the consumer thread obtains resources from the resource set through the consumer-type .

At step S202, a first waiting queue is configured for the first monitor, and a second waiting queue is configured for the second monitor. The waiting queues are managed by the monitors, where when the threads cannot obtain the requested resource or space, they are put into different waiting queues by the respective monitors based on the types of the threads, for example, putting the producer threads into a waiting queue, and putting the consumer threads in the other waiting queue, to await being awakened by the monitors, thereby preventing sleep of the producer threads and the consumer threads.

At step S203, in response to the first access interface receiving an access request for resource from a thread, the first monitor queries whether the resource set has a resource that satisfies the access request. According to the embodiments of the present invention, for a producer thread, what is requested is the available space of the resource set; for a consumer thread, what is requested is data in the resource set; at step S204, in response to a positive query result, the thread obtains a resource and notifies the second monitor to awake the thread in the second waiting queue; at step S205, in response to a negative query result, the first monitor puts the thread in the first waiting queue to queue up.

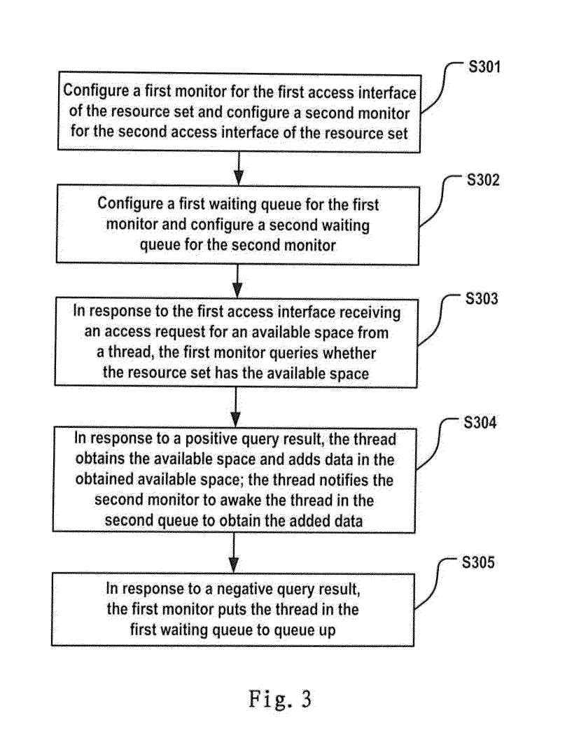

FIG. 3 illustrates a method of synchronizing Java resource access according to an embodiment of the present invention, where the first access interface is a producer-type access interface and the second access interface is a consumer-type access interface, and the first waiting queue contains a producer thread, and the second waiting queue contains a consumer thread. At step S301, a first monitor is configured for a first access interface of a resource set, and a second monitor is configured for a second access interface of the resource set. At step S302, a first waiting queue is configured for the first monitor, and a second waiting queue is configured for the second monitor.

At step S303, in response to the first access interface receiving an access request for a resource set from a thread, the first monitor querying whether the resource set has a requested resource further includes, in response to a first access interface receiving a request for accessing an available space from the thread, the first monitor queries whether the resource set has available space, and the thread calls the first monitor to query whether the resource set has available space. At step S304, in response to a positive query result, the thread obtaining the resource and the thread notifying the second monitor to awake the thread in the second waiting queue further includes the thread obtaining the available space in the resource set and adding data to the obtained available space and the thread awakening the thread in the second waiting queue to obtain the data added in the resource set. At step S305, in response to a negative querying result, the first monitor puts the thread into the first waiting queue to queue up, so as to wait for the resource set to release available space.

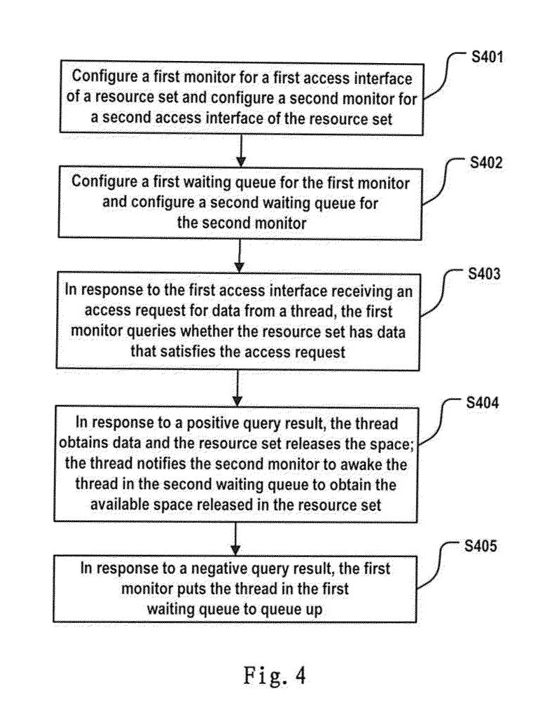

FIG. 4 illustrates a method of synchronizing Java resource access according to another embodiment of the present invention, where the first access interface is a consumer-type access interface and the second access interface is a producer-type access interface, where the first waiting queue contains a consumer thread, and the second waiting queue contains a producer thread. At step S401, a first monitor is configured for a first access interface of a resource set, and a second monitor is configured for a second access interface of the resource set. At step S4302, a first waiting queue is configured for the first monitor, and a second waiting queue is configured for the second monitor. At step S403, in response to the first access interface receiving an access request for a resource from a thread, the first monitor querying whether the resource set has a requested resource further includes, in response to the first access interface receiving an access request for data from a thread, the first monitor querying whether the resource set has data.

At step S404, in response to a positive query result, the thread obtains data in the resource set, and the thread notifies the second monitor to awake a thread in the second waiting queue to obtain the available space released in the resource set. Specifically, if the first monitor confirms that the resource set has data the thread obtains the data in the resource set, and the resource set releases the occupied space. Meanwhile, the thread notifies the second monitor to awake the thread in the second waiting queue to obtain the available space released in the resource set. At step S405, in response to a negative query result, the first monitor puts the thread into the first waiting queue to queue up.

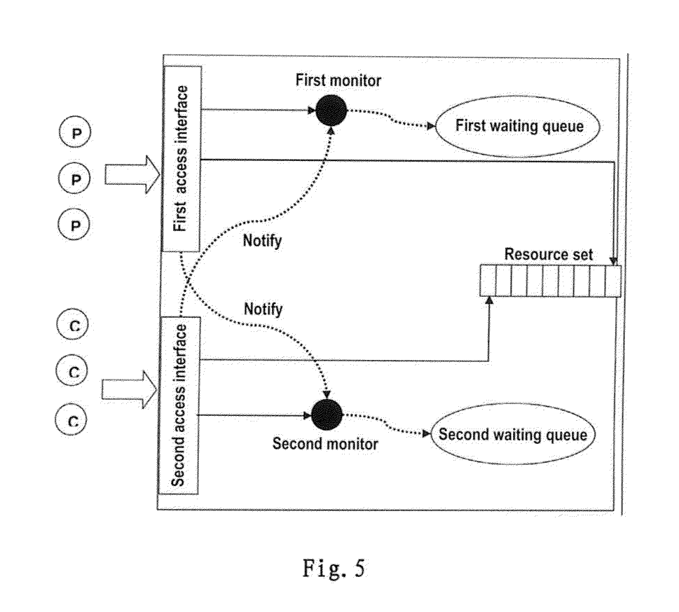

FIG. 5 illustrates a schematic diagram of a mechanism of synchronizing Java resource access according to the embodiments of the present invention. As illustrated in the figure, the synchronization mechanism configures a plurality of monitors with respect to different types of access interfaces and classifies the threads based on the types of method calls made by the threads. According to the embodiments of the present invention, the threads are categorized into producer threads and consumer threads when interfaces are accessed, where the producer threads P1, P2, and P3 add resources to the resource set via the first access interface, i.e., adding data; the consumer threads C1, C2, and C3 obtain resources from the resource set via the second access interface, i.e., obtaining data. The threads are categorized into different waiting queues based on the types of the threads, for example, the first waiting queue contains producer threads, and the second waiting queue contains consumer threads.

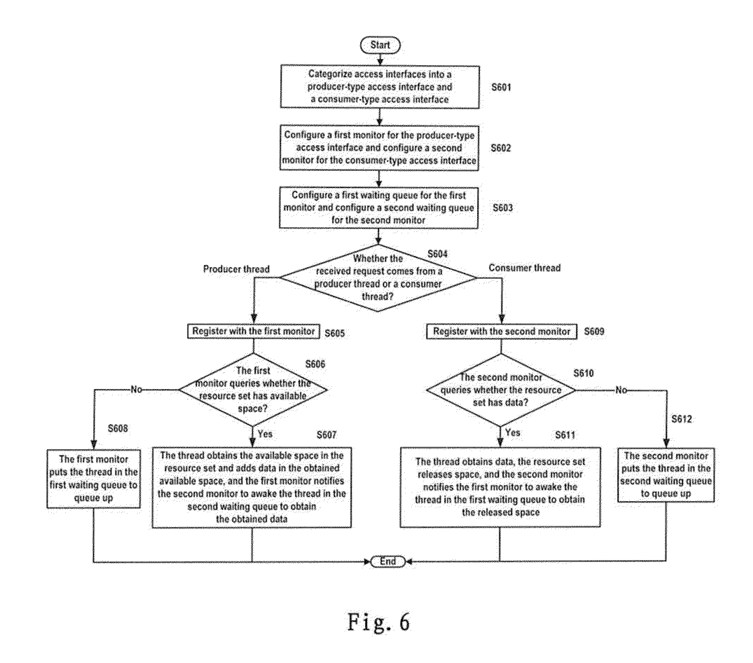

FIG. 6 is a flow chart of a mechanism of synchronizing Java resource access according to embodiments of the present invention. First, at step S601, the access interfaces are categorized into a producer-type access interface and a consumer-type access interface; at step S602, a first monitor is configured for the producer-type access interface, and a second monitor is configured for a consumer-type access interface; at step S603, a first waiting queue is configured for the first monitor, and a second waiting queue is configured for the second monitor. At step S604, it is determined whether the received resource access request comes from a producer thread or a consumer thread.

In case of the producer thread, then the process proceeds to step S605, where the producer thread is registered on the first monitor; at step S606, the first monitor queries whether the resource set has available space; in case of a positive query result, the process proceeds to step S607, where the thread obtains the available space in the resource set and adds data to the obtained available space, and the threads notifies the second monitor to awake the thread in the second waiting queue to obtain the newly available data, and then the process ends. In the case of a negative query result, then at step S608, the first monitor puts the thread into the first waiting queue to queue up, and then the process ends.

In the case of a consumer thread, then the process proceeds to step S609, where the consumer thread is registered on the second monitor; at step S610, the second monitor queries whether the resource set has data; in case of a positive query result, then the process proceeds to step S611, where the thread obtains the data in the resource set, and the resource set releases an available space, and the thread notifies the first monitor to awake the thread in the first waiting queue to obtain the available space, and then the process ends. In case of a negative query result, then at step S612, the second monitor puts the thread into the second waiting queue to queue up, and then the process ends.

The present invention configures monitors for different types of access interfaces respectively; the monitors are utilized to awake the producer thread and the consumer thread in different waiting queues respectively, to thereby prevent the producer thread and consumer thread from starving, reduce system response time, and improve resource access efficiency.

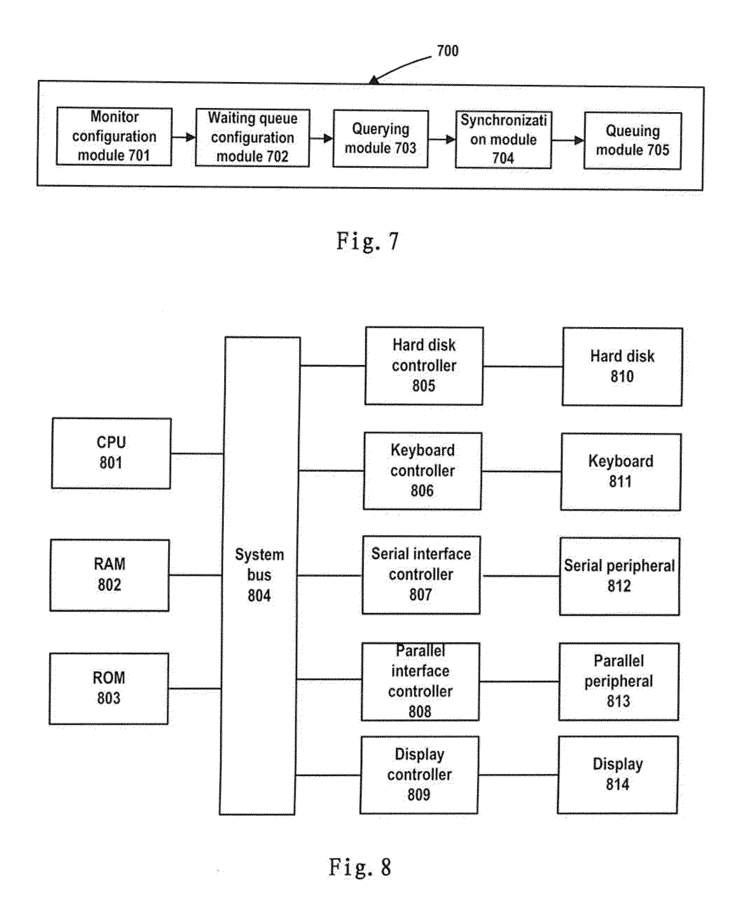

Based on the same inventive concept, the present invention provides an apparatus of synchronizing Java resource access. FIG. 7 illustrates an apparatus for synchronizing Java resource access according to an embodiment of the present invention, the apparatus includes a monitor configuration module 701 configured to configure a first monitor for a first access interface of a resource set and to configure a second monitor for a second access interface of the resource set; a waiting queue configuration module 702 configured to configure a first waiting queue for the first monitor and to configure a second waiting queue for the second monitor; a querying module 703 configured in a way that in response to the first access interface receiving an access request for a resource from a thread, the first monitor queries whether the resource set has a resource that satisfies the access request; a synchronization module 704 configured in a way that in response to a positive query result, the thread obtains the resource and notifies the second monitor to awake the thread in the second waiting queue; and a queuing module 705 configured in a way that in response to a negative querying result, the first monitor puts the thread into a first waiting queue to queue up.

According to an embodiment of the present invention, the first access interface is a producer-type access interface and the second access interface is a consumer-type access interface, where the first waiting queue contains a producer thread, and the second waiting queue includes a consumer thread. According to the embodiments of the present invention, the querying module is further configured in a way that in response to the first access interface receiving an access request for available space from a thread, the first monitor queries whether the resource set has available space. The synchronization module is further configured in a way that the thread obtains the available space in the resource set and adds data to the obtained available space; the thread awakes the thread in the second waiting queue to obtain the data added in the resource set.

According to another embodiment of the present invention, the first access interface is a consumer-type access interface and the second access interface is a producer-type access interface, where the first waiting queue includes a consumer thread, and the second waiting queue contains a producer thread. The querying module is further configured in a way that in response to the first access interface receiving an access request for data from a thread, the first monitor queries whether the resource set has data. The synchronization module is further configured in a way that in response to a positive query result, the thread obtains the data in the resource set; the resource set releases the available space; the thread notifies the second monitor to awake the a thread in the second waiting queue to obtain the released available space in the resource set.

FIG. 8 schematically illustrates a structural block diagram of a computing device capable of implementing the embodiments according to the present invention. The computer system as shown in FIG. 8 includes a CPU (Central Processing Unit) 801, a RAM (Random Access Memory) 802, a ROM (Read Only Memory) 803, a system bus 804, a hard disk monitor 805, a keyboard monitor 806, a serial interface monitor 807, a parallel interface monitor 808, a display monitor 809, a hard disk 810, a keyboard 811, a serial peripheral 812, a parallel peripheral 813 and a display 814. Among these components, connected to the system bus 804 are the CPU 801, the RAM 802, the ROM 803, the hard disk monitor 805, the keyboard monitor 806, the serial interface monitor 807, the parallel interface monitor 808 and the display monitor 809. The hard disk 810 is connected to the hard disk monitor 805; the keyboard 811 is connected to the keyboard monitor 806; the serial peripheral 812 is connected to the serial interface monitor 807; the parallel peripheral 813 is connected to the parallel interface monitor 808; and the display 814 is connected to the display monitor 809.

The functions of respective components in FIG. 8 are known in the art, and the structure of FIG. 8 is also conventional. This structure is not only used for a personal computer, but for a portable device, for example, Palm PC, PDA (personal digital assistance), and a mobile telephone, etc. In different applications, for example, when it is applied to implement a user terminal including a client module according to the present invention or a server host comprising a network application server according to the present invention, some components may be added in the structure of FIG. 8, or some components in FIG. 8 may be omitted. The entire system illustrated in FIG. 8 may be stored in the hard disk 810 as software or stored in an EPROM or other non-volatile memories as a computer readable instruction control. The software may be downloaded from the network (not shown). Or the software may be stored in the hard disk 810. Or the software downloaded from the network may be loaded into RAM 802 and executed by the CPU 801 so as to complete the functions determined by the software.

Although the computer system described in FIG. 8 is capable of supporting the technical solution as provided according to the present invention, the computer system is only an example of computer systems. Those skilled in the art may understand that many other computer system designs may also implement the embodiments of the present invention.

Although the exemplary embodiments of the present invention are described herein with reference to the drawings, it should be understood that the present invention is not limited to these accurate embodiments, and those of ordinary skill in the art can carry out various kinds of modifications to the embodiments without departing from the scope and principle of the present invention. All such variations and modifications are intended to be included in the scope of the present invention as limited in the appended claims.

It should be understood that at least some aspects of the present invention may be implemented alternatively by a program product. A program defining functions about the present invention may be transferred to a data storage system or a computer system through various kinds of signal bearing mediums, where the signal bearing medium includes, but not limited to, a non-writable storage medium (for example, CD-ROM), a writable storage medium (for example, floppy disk, a hard disk driver, a read/write CD ROM, optical medium), and a telephone network such as a computer including Ethernet and a communication medium. Thus, it should be understood that when this kind of signal bearing medium carries or is encoded with a computer readable instruction for managing the method functions in the present invention, it represents an alternative embodiment of the present invention.

The present invention may be implemented in hardware, software, firmware or a combination thereof. The present invention may be implemented in a computer system in a collective or distributive manner, where in the distributive manner; different parts are distributed in a plurality of interconnected computer systems. Any computer system or other apparatus suitable for implementing the method as depicted herein is suitable. Preferably, the present invention is implemented by a combination of computer software and general computer hardware. In this implementation, when the computer program is loaded and executed, it controls the computer system to execute the method according to the present invention or constituting a system of the present invention.

For the purpose of exemplary illustration, the illustration of preferred embodiments of the present invention has been illustrated. The above illustration of the preferred embodiments is not exhaustive or intended to limit the present invention in an explicitly disclosed manner, and obviously, in view of the above teaching, many modifications and variations are possible. It is apparent to those skilled in the art that such amendments and variations are included within the scope of the present invention as limited in the appended claims.

We claim:

1. A method of synchronizing Java resource access, the method comprising:
configuring a first monitor, for a first access interface of a resource set, and a second monitor, for a second access interface of the resource set;
configuring a first waiting queue, for the first monitor, and a second waiting queue, for the second monitor;
in response to the first access interface receiving an access request for a resource from a thread, the first monitor querying whether the resource set has a resource that satisfies the access request;
in response to a positive query result, the thread obtaining the resource and notifying the second monitor to awake a thread in the second waiting queue; and
in response to a negative query result, the first monitor putting the thread into the first waiting queue to queue up.

2. The method of synchronizing according to claim 1, wherein the first access interface is a producer-type access interface and the second access interface is a consumer -type access interface.

3. The method of synchronizing according to claim 2, wherein the first waiting queue contains a producer thread and the second waiting queue contains a consumer thread.

4. The method of synchronizing according to claim 3, wherein in response to the first access interface receiving an access request for a resource from a thread, the first monitor querying whether the resource set has a resource that satisfies the access request further comprising:
in response to the first access interface receiving an access request for available space from a thread, the first monitor querying whether the resource set has available space.

5. The method of synchronizing according to claim 4, wherein the thread obtaining the resource and notifying the second monitor to awake a thread in the second waiting queue comprises:
the thread obtaining the available space in the resource set and adding data to the obtained available space; and
the thread notifying the second monitor to awake the thread in the second waiting queue to obtain the data added in the resource set.

6. The method of synchronizing according to claim 1, wherein the first access interface is a consumer-type access interface and the second access interface is a producer -type access interface.

7. The method of synchronizing according to claim 6, wherein the first waiting queue contains a consumer thread and the second waiting queue contains a producer thread.

8. The method of synchronizing according to claim 7, wherein in response to the first access interface receiving an access request for a resource from a thread, the first monitor querying whether the resource set has a resource that satisfies the access request further comprising:
in response to the first access interface receiving an access request for data from a thread, the first monitor querying whether the resource set has data.

9. The method of synchronizing according to claim 8, wherein the thread obtaining the resource and notifying the second monitor to awake a thread in the second waiting queue comprises:
the thread obtaining the data in the resource set;
the resource set releasing available space; and
the thread notifying the second monitor to awake the thread in the second waiting queue to obtain the released available space in the resource set.

10. An apparatus for synchronizing Java resource access, the apparatus comprising:
a monitor configuration module to configure a first monitor, for a first access interface of a resource set, and a second monitor for a second access interface of the resource set;
a waiting queue configuration module to configure a first waiting queue, for the first monitor, and a second waiting queue for the second monitor;
a querying module configured in a way that in response to the first access interface receiving an access request for a resource from a thread, the first monitor queries whether the resource set has a resource that satisfies the access request;
a synchronization module configured in a way that in response to a positive query result, the thread obtains the resource and notifies the second monitor to awake a thread in the second waiting queue; and
a queuing module configured in a way that in response to a negative query result, the first monitor puts the thread into the first queue to queue up.

11. The apparatus for synchronizing according to claim 9, wherein the first access interface is a producer-type access interface and the second access interface is a consumer -type access interface.

12. The apparatus of synchronizing according to claim 10, wherein the first waiting queue contains a producer thread and the second waiting queue contains a consumer thread.

13. The apparatus of synchronizing according to claim 11, wherein the querying module is further configured in a way that in response to the first access interface receiving an access request for available space from a thread, the first monitor queries whether the resource set has available space.

14. The apparatus for synchronizing according to claim 12, wherein the thread obtaining the resource and the first monitor notifying the second monitor to awake a thread in the second waiting queue comprises:
the thread obtaining the available space in the resource set and adding data to the obtained available space; and
the thread notifying the second monitor to awake the thread in the second waiting queue to obtain the data added in the resource set.

15. The apparatus for synchronizing according to claim 9, wherein the first access interface is a consumer-type access interface and the second access interface is a producer -type access interface.

16. The apparatus for synchronizing according to claim 14, wherein the first waiting queue contains a consumer thread and the second waiting queue contains a producer thread.

17. The apparatus for synchronizing according to claim 16, wherein the querying module is further configured in a way that in response to the first access interface receiving an access request for data from a thread, the first monitor queries whether the resource set has data.

18. The apparatus for synchronizing according to claim 17, wherein the synchronization module is further configured in a way that:
in response to a positive query result, the thread obtains data in the resource set;
the resource set releases available space; and
the thread notifies the second monitor to awake the thread in the second waiting queue to obtain the released available space in the resource set.

19. A computer readable non-transitory storage medium tangibly embodying a computer readable program code having computer readable instructions which, when implemented, cause a computer to carry out the steps of a method comprising:
configuring a first monitor, for a first access interface of a resource set, and a second monitor, for a second access interface of the resource set;
configuring a first waiting queue, for the first monitor, and a second waiting queue, for the second monitor;
in response to the first access interface receiving an access request for a resource from a thread, the first monitor querying whether the resource set has a resource that satisfies the access request;
in response to a positive query result, the thread obtaining the resource and notifying the second monitor to awake a thread in the second waiting queue; and
in response to a negative query result, the first monitor putting the thread into the first waiting queue to queue up.
